(19) United States
(12) Patent Application Publication
(10) Pub. No.: US 2026/0370449 A1
(43) Pub. Date: Nov. 19, 2026

(54) COMPRESSION SYSTEM FOR HOMOMORPHIC ENCRYPTED DATA IN A MEMORY SYSTEM

(71) Applicant: Micron Technology, Inc., Boise, ID (US)

(72) Inventor: Poorna Kale, Folsom, CA (US)

(21) Appl. No.: 19/669,546

(22) Filed: May 6, 2026

Related U.S. Application Data
(60) Provisional application No. 63/807,326, filed on May 16, 2025.

(51) Int. Cl. H04L 9/00

(52) U.S. Cl. CPC H04L 9/008

(57) ABSTRACT

An apparatus can include expansion memory and a compression core. The expansion memory can store homomorphic encrypted (HE) data. The compression core can comprise a machine learning model. The compression core can be coupled to the expansion memory and can access the HE data from the expansion memory. The compression core can compress the HE data utilizing the machine learning model based on a type of the HE data. The compression core can provide the compressed HE data for storage back to the expansion memory.

### PRIORITY INFORMATION

This Application claims the benefit of U.S. Provisional Application No. 63/807,326, filed on May 16, 2025, the contents of which are incorporated herein by reference.

### TECHNICAL FIELD

Embodiments of the disclosure relate generally to memory systems, and more specifically, relate to implementing a compression system for homomorphic encrypted data in a memory system.

### BACKGROUND

A computing system can include a memory system, which can be a storage device, a memory module, or a hybrid of a storage device and a memory module. Examples of a storage device include a solid-state drive (SSD), a Universal Flash Storage (UFS) drive, a secure digital (SD) card, an embedded Multiple Media Card (eMMC), and a hard disk drive (HDD). Examples of memory modules include a dual in-line memory module (DIMM) and various types of non-volatile dual in-line memory modules (NVDIMMs). A memory system includes one or more memory devices (e.g., storage devices) that store data. The memory devices can be, for example, non-volatile memory devices (e.g., NAND flash memory systems) and volatile memory devices (e.g., DRAM devices). The memory devices can include compute express link (CXL) memory or peripheral component interconnect express (PCIe) memory. In general, a host system can utilize a memory system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 is a functional block diagram of a computing system including a memory system in accordance with a number of embodiments of the present disclosure.

FIG. 2 is a functional block diagram of a compression system in accordance with a number of embodiments of the present disclosure.

FIG. 3 is a flow diagram for model training in accordance with a number of embodiments of the present disclosure.

FIG. 4 is a flow diagram for model training in accordance with a number of embodiments of the present disclosure.

FIG. 5 is a flow diagram of a method for implementing a compression system for homomorphic encrypted data in a memory system in accordance with a number of embodiments of the present disclosure.

FIG. 6 illustrates an example machine of a computer system within which a set of instructions, for causing the machine to perform any one or more of the methodologies discussed herein, can be executed.

### DETAILED DESCRIPTION

A compression system for homomorphic encrypted (HE) data in a memory system is described. The compression system can be included in an apparatus such as a memory system. A memory system can be a storage device, a memory device, or a combination of such. An example of a memory system is expansion memory.

As used herein, expansion memory describes a device that can be coupled and decoupled from a computing system. For example, expansion memory describes a memory that can be coupled to a mother board of the computing system. The expansion memory can be a memory system and/or a memory device of the memory system. The expansion memory can be implemented in combination with a memory controller and/or other memory devices.

HE faces challenges due to the large size of encrypted data. HE can overwhelm traditional memory systems and can result in poor performance. Conventional compression algorithms struggle with HE data because the encryption of the HE data hides patterns that conventional compression utilizes to compress data. The variable nature of homomorphic encryption further complicates adopting a universal compression solution.

A memory system that stores the HE data in expansion memory (e.g., memory device) lacks specialized mechanisms to handle large HE payloads efficiently. There is a need for an adaptive approach to compress encrypted data in real time, maintaining cryptographic properties while optimizing data transfer bandwidth.

In some embodiments, the expansion memory can operate according to a non-deterministic memory protocol compliant memory system such as a compute express link (CXL) compliant memory, universal accelerator link (UAL) memory, and/or peripheral component interconnect express (PCIe) memory. For instance, the host interface can be managed with CXL protocols and can be coupled to the host via an interface configured for a peripheral component interconnect express (PCIe) protocol. CXL is a high-speed central processing unit (CPU)-to-device and CPU-to-memory interconnect designed to accelerate next-generation data center performance. CXL technology maintains memory coherency between the CPU memory space and memory on attached devices, which allows resource sharing for higher performance, reduced software stack complexity, and lower overall memory system cost. CXL is designed to be an industry open standard interface for high-speed communications, as accelerators are increasingly used to complement CPUs in support of emerging applications such as artificial intelligence and machine learning. CXL technology is built on the PCIe infrastructure, leveraging PCIe physical and electrical interfaces to provide advanced protocol in areas such as input/output (I/O) protocol, memory protocol (e.g., initially allowing a host to share memory with an accelerator), and coherency interface.

Aspects of the present disclosure address the above and other deficiencies by introducing an intelligent compression system for homomorphically encrypted workloads stored in expansion memory (e.g., expansion memory devices). The compression system can utilize machine-learning models to adjust compression strategies based on statistical cues in encrypted data while maintaining cryptographic protections.

Unlike basic compression methods, the compression system described herein can combine pattern recognition with hardware acceleration. The compression system can leverage real-time feedback to enhance memory efficiency, reduce latency, and save power.

As used herein, AI refers to the ability to improve an apparatus through “learning” such as by storing patterns and/or examples which can be utilized to take actions at a later time. Machine learning is a broad field that involves training computer systems to learn from data and make predictions or decisions. Deep learning is a subset of ML that uses artificial neural networks to analyze data.

Neural networks, among other types of networks, can be classified as deep learning. Deep neural networks (DNN) can be used in machine learning tasks such as image classification, speech recognition, anomaly detection, compression, and/or decompression, among other types of machine learning tasks. Artificial neural networks (ANNs) are networks that can process information by modeling a network of neurons, such as neurons in a human brain, to process information (e.g., stimuli) that has been sensed in a particular environment. Similar to a human brain, neural networks typically include a multiple neuron topology, which can be referred to as artificial neurons or units. An ANN operation refers to an operation that processes inputs using units to perform a given task. The ANN operation may involve applying various machine learning algorithms to process the inputs. Example tasks that can be processed by performing ANN operations can include machine vision, speech recognition, machine translation, social network filtering, and medical diagnosis, among others. An ANN can perform machine learning tasks by performing a weighted combination of inputs (either from the network input or a previous layer) at each unit to generate an output. The probability weight associations can be provided by a plurality of units that comprise the ANN. The units together with weights, biases, embeddings, and/or activation functions can be used to generate an output of the ANN based on the input to the ANN. Units of the ANN can be grouped to form layers of the ANN. The ANN can implement or represent an algorithm consisting of a series of connected layers that process signals based on outputs from other ones of the series of connected layers.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. It is to be understood that data can be transmitted, received, or exchanged by electronic signals (e.g., current, voltage, etc.) and that the phrase “signal indicative of [data]” represents the data itself being transmitted, received, or exchanged in a physical medium. The signal can correspond to a command (e.g., a read command, a write command, etc.).

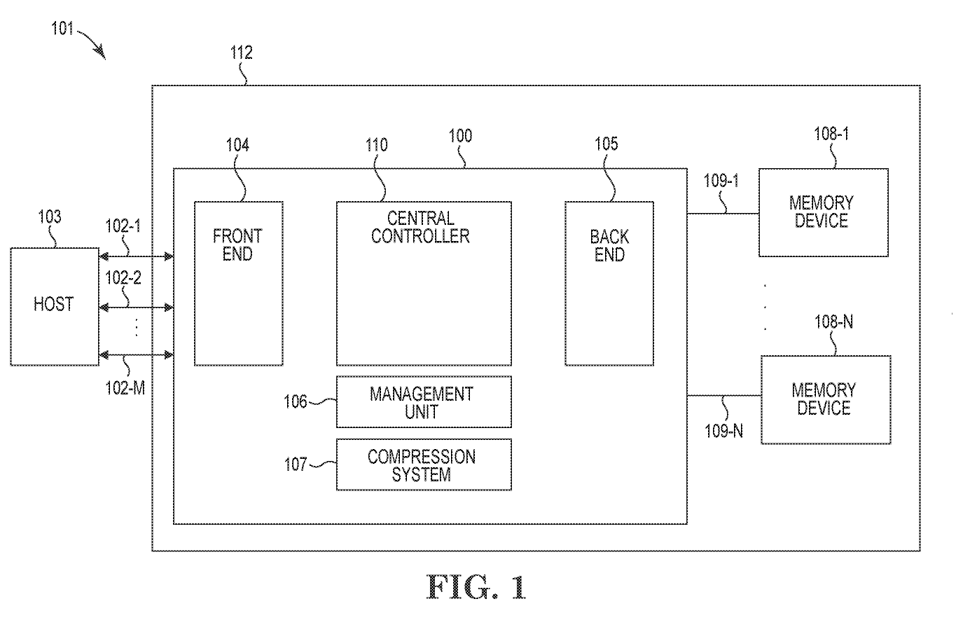

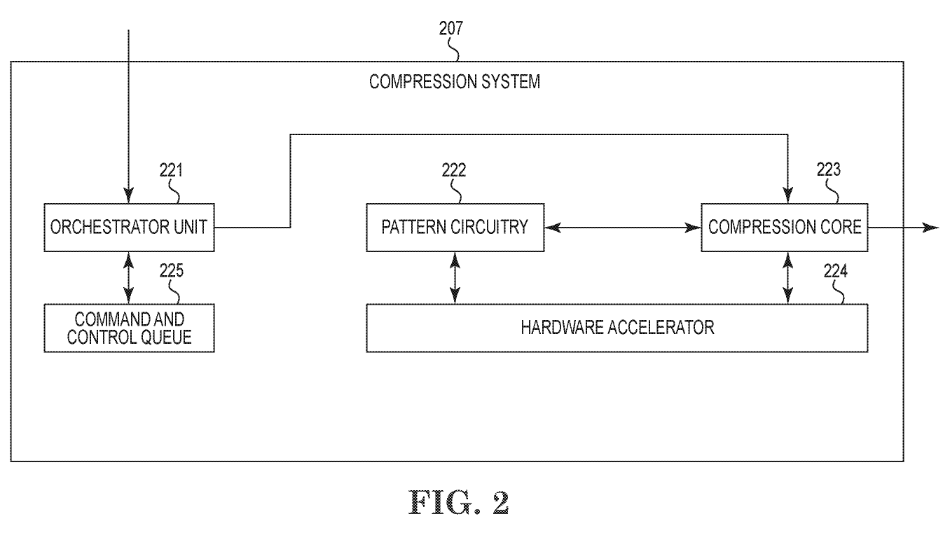

The figures herein follow a numbering convention in which the first digit or digits correspond to the drawing figure number and the remaining digits identify an element or component in the drawing. Similar elements or components between different figures may be identified by the use of similar digits. For example, 107 may reference element “07” in FIG. 1, and a similar element may be referenced as 207 in FIG. 2. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a functional block diagram of a computing system 101 including a memory system 112 in accordance with a number of embodiments of the present disclosure. The memory system 112 can include a memory controller 100. The memory controller 100 can include a front-end portion 104, a central controller portion 110, and a back-end portion 105. The computing system 101 can include a host 103 and the memory system 112. The memory system 112 can include the memory devices 108-1,…,108-N coupled to the memory controller 100.

The memory controller 100, which is coupled to the host 103, can be discrete from the one or more of the memory devices 108-1,…,108-N. The host 103 may include a system that may write data to the memory devices 108-1…108-N and/or read data from the memory devices 108-1…108-N. For example, the host 103 may write data to the memory devices 108-1…108-N utilizing the memory controller 100 and/or may read data from the memory devices 108-1…108-N utilizing the memory controller 100 of the memory system 112. For example, the host 103 may generate and/or communicate requests executable by the memory controller 100 to write data to and/or read data from the memory devices 108-1…108-N.

The host 103 may be a computing device such as a desktop computer, laptop computer, network server, mobile device, or other such computing device that includes memory and a processing device. The host 103 may include, or be coupled to, the memory controller 100 and/or the memory devices 108-1…108-N so that the host 103 can read data from or write data to the memory devices 108-1…108-N. The host 103 may be coupled to the memory controller 100 and/or the memory devices 108-1…108-N via a physical interface. In some examples, the front-end portion 104 of the memory controller 100 may form a portion of that physical interface.

The front-end portion 104 includes an interface and interface management circuitry to couple the memory controller 100 to the host 103 through input/output (I/O) lines 102-1, 102-2,…, 102-M and circuitry to manage the I/O lines 102. There can be any quantity of I/O lines 102, such as eight, sixteen, or another quantity of I/O lines 102. In some embodiments, the I/O lines 102 can be configured as a single port. In at least one embodiment, the interface between the memory controller 100 and the host 103 can be a PCIe physical and electrical interface operated according to a CXL protocol.

The central controller portion 110 can include and/or be referred to as data management circuitry. The central controller portion 110 can control, in response to receiving a request from the host 103, performance of a memory operation. Examples of the memory operation include memory access request such as a read operation to read data from a memory device 108 or a write operation to write data to a memory device 108.

The back-end portion 105 can include a media controller and a physical (PHY) layer that couples the memory controller 100 to the memory devices 108. As used herein, the term “PHY layer” generally refers to the physical layer in the Open Systems Interconnection (OSI) model of a computing system. The PHY layer may be the first (e.g., lowest) layer of the OSI model and can be used to transfer data over a physical data transmission medium. In some embodiments, the physical data transmission medium can include channels 109-1,…, 109-N. The channels 109 can include a sixteen pin data bus and a two pin data mask inversion (DMI) bus, among other possible buses. The back-end portion 105 can exchange (e.g., transmit or receive) data with the memory devices 108 via the data pins.

An example of the memory devices 108 is dynamic random access memory (DRAM) operated according to a protocol such as low-power double data rate (LPDDRx), which may be referred to herein as LPDDRx DRAM devices, LPDDRx memory, etc. The “x” in LPDDRx refers to any of a number of generations of the protocol (e.g., LPDDR5). Another example of a memory device 108 is CXL memory.

In some embodiments, the memory controller 100 can include a management unit 106 to initialize, configure, and/or monitor characteristics of the memory controller 100. The management unit 106 can include an I/O bus to manage out-of-band data and/or commands, a management unit controller to execute instructions associated with initializing, configuring, and/or monitoring the characteristics of the memory controller, and a management unit memory to store data associated with initializing, configuring, and/or monitoring the characteristics of the memory controller 100. As used herein, the term “out-of-band” generally refers to a transmission medium that is different from a primary transmission medium of a network. For example, out-of-band data and/or commands can be data and/or commands transferred to a network using a different transmission medium than the transmission medium used to transfer data within the network.

In addition, the memory controller 100 can include the compression system 107. However, as detailed herein, in some embodiments the compression system 107 can be located elsewhere within the memory controller 100 (e.g., front-end 104, back-end 105, central controller 110 etc.). For example, the compression system 107 may be located in the central controller 110, the back-end 105, a bank controller for a memory devices 108-1…108-N, a channel controller for a memory devices 108-1…108-N, or combinations thereof.

The compression system 107 may include circuitry and/or instructions executable to compress HE data. The compression system 107 introduces an intelligent compression module for HE workloads in CXL-compatible memory system such as the memory system 112. The compression system 107 uses machine-learning models to adjust compression strategies based on statistical cues identified in encrypted data while maintaining cryptographic protections of the compressed HE data.

Unlike basic compression methods, this compression system 107 combines pattern-recognition algorithms with hardware acceleration. The compression system 107 leverages real-time feedback and encrypted data streams to enhance memory efficiency, reduce latency, and save power.

The compression system 107 can receive HE data from the host 103 via the I/O lines 102. For example, the HE data can be provided from the host 103 to the memory system 112. The memory system 112 can receive the HE data at the front-end portion 104 of the memory controller 100. The front-end portion 104 can provide the HE data to the central controller 110 or the back-end 105 can provide the HE data to the central controller 110 after the HE data has been stored in one or more of the memory devices 108. The central controller 110 can provide the HE data to the compression system 107. The compression system 107 can perform a plurality of operations to compress the HE data. The compression system 107 can recognize patterns in the HE data and can replace the patterns with compression tokens. As used herein, compression tokens describe predefined strings of bits which can be used to identify corresponding patterns.

The compression system 107 can identify the patterns utilizing hardware accelerators of the memory system 112. The hardware accelerators can employ machine learning to identify complex patterns in the HE data. The HE data can include the encrypted data and the metadata associated with the encrypted data. Th hardware accelerators can identify the patters in the encrypted data and/or the metadata. The compressed HE data can be stored in the memory devices 108. For example, the compression system 107 can provide the compressed HE data to the central controller 110. The central controller 110 can provide the compressed HE data to the back-end portion 105. The back-end portion can provide the compressed HE data to the memory devices 108 via the channels 109.

The compression system 107 can also be utilized to decompress the compressed HE data. For example, the host 103 can provide a read command to access the compressed HE data to the memory system 112. The memory system 112 can receive the read command via the front-end portion 104 and can provide the read command to the central controller 110. The central controller 110 can identify a memory device that stored the compressed HE data. The central controller 110 can provide the read command to the back-end portion 105. The back-end portion 105 can provide the read command to the corresponding memory device from the memory devices 108. The corresponding memory device can sense (e.g., read) and provide the compressed HE data to the memory controller 110. The memory controller 100 can receive the compressed HE data at the back-end portion 105. The back-end portion 105 can provide the compressed HE data to the central controller 110. The central controller 110 can provide the compressed HE data to the compression system 107.

The compression system 107 can perform a plurality of operations to decompress the HE data. For example, the compression system 107 can cause the compression tokens to be replaced with the patterns. The original HE data that has been decompressed can be provided from the compression system 107 to the central controller 110. The central controller can provide the HE data to the host 103 via the front-end portion 104 and the lines 102.

FIG. 2 is a functional block diagram of a compression system 207 in accordance with a number of embodiments of the present disclosure. The compression system 207 is analogous to the compression system 107 of FIG. 1. The compression system 207 can include an orchestrator unit 221, pattern circuitry 222, a compression core 223, a hardware acceleration 224, and a command-and-control circuitry 225.

The orchestrator unit 221 comprises hardware and/or firmware. The orchestrator unit 221 can serve as the interface between the central controller 110 of FIG. 1 and the compression system 207. The compression system 207 can be defined as compression hardware that utilizes machine learning to perform compression operations. The orchestrator unit 221 negotiates metadata, sets operation modes, and/or relays instructions regarding which compression or decompression procedure to apply.

For example, the orchestrator unit 221 can receive metadata and HE data. The orchestrator unit 221 can utilize the metadata corresponding to the HE data to set operation modes and relay instructions regarding which compression or decompression procedure to apply. For instance, the orchestrator unit 221 can determine based on metadata whether the HE data is compressed or uncompressed. If the HE data is compressed, the orchestrator unit 221 can set a mode of the orchestrator unit 221 to perform decompression. If the HE data is decompressed, the orchestrator unit 221 can set the mode of the orchestrator unit 221 to perform compression. The orchestrator unit 221 can set a mode register of the compression system 207 to indicate that the compression system 207 is to perform compression or is to perform decompression. The pattern circuitry 222, the compression core 223, the command-and-control circuitry 225, and/or the accelerator 224 can access the mode registers to determine their function based on whether the orchestrator unit 221 is set to perform compression or decompression on the HE data.

The pattern circuitry 222 comprises hardware and/or firmware. The pattern circuitry 222 can maintain entries of recurring ciphertext segments and associated compression tokens. The ciphertext segments can be data patterns that are repeated in the HE data. The ciphertext segments can describe a plurality of bits of HE data and/or metadata. The data patterns can be referred to as a pattern because the data patterns can occur a plurality of times in the HE data. The plurality of bits of the compression token are fewer than the quantity of bits of the ciphertext segment.

The pattern circuitry 222 can include memory for storing the recurring ciphertexts segments and corresponding compression tokens. The pattern circuitry 222 can create an association between the recurring ciphertexts segments and the corresponding compression tokens. For example, the pattern circuitry 222 can create the associations between the cyphertexts segments and compression tokens utilizing one or more tables.

The pattern circuitry 222 can receive and store new data patterns. The pattern circuitry 222 can assign compression tokens to the newly stored data patterns. In various instances, the pattern circuitry 222 can receive new data patterns and compression tokens. The pattern circuitry 222 can associate the new data patterns with the compression tokens. The pattern circuitry 222 can store the new data patterns and the compression tokens.

The pattern circuitry 222 can be queried to determine whether a data pattern is new or if the data pattern has previously been stored by the pattern circuitry 222. The pattern circuitry 222 can receive a data pattern. The pattern circuitry 222 can compare the data pattern to previously stored data patter. If the pattern circuitry 222 identifies that the data pattern has not been previously stored by the pattern circuitry 222, the pattern circuitry can store the data pattern, can create a compression token, and/or can return a compression token. If the pattern circuitry 222 identifies that the data pattern has been previously stored by the pattern circuitry 222, the pattern circuitry 222 can access a corresponding compression token by referencing an association between the data pattern and the compression token. The pattern circuitry 222 can then return the compression token.

The compression core 223 can also comprise hardware and/or firmware. The compression core 223 can identify structural redundancies within the HE data utilizing a compression model that includes a machine learning model implemented by the hardware accelerator 224. The compression core 223 can continuously refine its compression model using a feedback loop that evaluates performance and adjusts parameters in real time (e.g., on the fly). A compression model describes a machine learning model used to identify data patterns and/or replace the data patterns with compression tokens in the compressed HE data. The compression core 223 can utilize the hardware accelerator 224 to identify data patterns in the HE data. The compression core 223 can configure the hardware accelerator 224. For example, the compression core 223 can determine which machine learning models are implemented by the hardware accelerator 224 to perform operations on the HE data, such as identifying data patterns in the HE data.

The hardware accelerator 224 can comprise one or more machine learning models. The one or more machine learning models can include artificial neural networks (ANNs) for example, among other types of machine learning models.

The hardware accelerator 224 can be configured to use a different model for different types of data used in the HE data. For example, the hardware accelerator 224 can be configured to utilize a first machine learning model to identify data patterns in the HE data having a first data type and a second machine learning model to identify data patterns in the HE data having a second data type. The types of data can include numbers and/or letters. The types of data can include image data, video data, and/or audio data, among other types of data that can be compressed.

In some examples, the hardware accelerator 224 can be configured to use a single machine learning model to identify data patterns in multiple HE data sets each having a different data type. For example, the hardware accelerator 224 can configure a machine learning model to identify data patterns in a first HE data using a first configuration. The hardware accelerator layer can configure the machine learning model to identify data patterns in a second HE data using a second configuration. A single machine learning model can be used to identify data patterns in HE data having different data types.

The command-and-control circuitry 225 can comprise hardware and/or firmware. The command-and-control circuitry 225 can handle multiple simultaneous requests for compression or decompression. For example, the command-and-control circuitry 225 can be configured to receive multiple requests for compressing or decompressing HE data. The command-and-control circuitry 225 can manage and schedule the requests based on a number of factors (e.g., priority). The command-and-control circuitry 225 can store the requests in a queue and can determine an order in which the requests are executed based on a priority of the requests and/or resources availability, among other criteria that can be used to determine an order in which the requests are executed. The command-and-control circuitry 225 can be configurable to schedule and orchestrate priority management based on system requirements and usage context to optimize latency reduction.

In a compression mode, a compression request and HE data can be received at the orchestrator unit 221. The orchestrator unit 221 can provide the compression request and/or the HE data to the command-and-control circuitry 225. Based on a schedule established by the command-and-control circuitry 225, the command-and-control circuitry 225 can provide the request and/or the HE data to the orchestrator unit 221. For example, the command-and-control circuitry 225 can store the requests and can provide the requests to the orchestrator unit 221 based on a schedule established by the command-and-control circuitry 225.

The orchestrator unit 221 can receive the request and/or the HE data and can provide the request and/or the HE data to the compression core 223. The compression core 223 can cause the hardware accelerator 224 to identify data patterns in the HE data. The hardware accelerator 224 can identify the data patterns. The compression core 223 can receive a list of patterns associated with the HE data from the hardware accelerator 224. The compression core 223 can also receive a location of the patterns in the HE data from the hardware accelerator 224.

The compression core 223 can query the pattern circuitry 222 for compression tokens corresponding to the data patterns. For example, the compression core 223 can provide the data patterns to the pattern circuitry 222. The pattern circuitry 222 can generate compression tokens for new data patterns and/or store the data patterns and the compression tokens. The pattern circuitry can access compression tokens for data patterns that were previously stored by the pattern circuitry 222. The pattern circuitry 222 can return the compression tokens to the compression core 223.

The compression core 223 can replace the data patterns with the compression tokens in the HE data to generate the compressed HE data. The compression core 223 can provide the compressed HE data to the central controller to cause the compressed data to be stored in the memory devices 108 of FIG. 1.

In a decompression mode, the orchestrator unit 221 can receive a request to decompress the compressed HE data and/or metadata. The orchestrator unit 221 can provide the compressed HE data and/or the request to the command-and-control circuitry 225. The orchestrator unit 221 can provide the request (e.g., request to decompress) to the command-and-control circuitry 225. The command-and-control circuitry 225 can schedule the request. The command-and-control circuitry 225 can provide the request and/or the compressed HE data to the orchestrator unit 221 at a scheduled time determined by the command-and-control circuitry 225. The orchestrator unit 221 can provide the request and/or the compressed HE data to the compression core 223.

The compression core 223 can extract compression tokens from the pattern circuitry 222. In various examples, the compression core 223 can utilize the accelerator 224 to identify and extract the tokens from the compressed HE data.

The compression core can query the pattern circuitry 222 by providing compression tokens to the pattern circuitry 222. The pattern circuitry 222 can identify data patterns associated with the compression tokens. The pattern circuitry 222 can return the data patterns to the compression core 223. The compression core 223 can replace the compression tokens with the data patterns provided by the pattern circuitry 222 to generate the decompressed HE data which can be the original HE data.

The compression core 223 can provide the HE data to the central controller of the memory system. The central controller can provide the HE data to the host, for example.

In a number of examples, the host system can provide HE data and metadata via a CXL interface (e.g., lines 112 of FIG. 1). The metadata can correspond to the HE data. For example, the metadata can describe the encryption scheme, among other aspects of the HE data that the metadata can describe.

The orchestrator unit 221 can configure the compression core 223 for optimal ciphertext compression and/or decompression. The orchestrator unit 221 can utilize previous results and performance metrics to configure the compression core 223. The configurations can define whether the compression core 223 is performing compression or decompression. The configurations can also define a type of data of the HE data. The types of data can include whether the data includes video data or image data, among other types of data. The types of data can also include compressed data or decompressed data. The configurations can also be used to provide a priority for the compression core 223. For example, the orchestrator unit 221 can configure the compression core 223 for optimal power efficiency, among other possible configurations.

The compression core 223 can segment data. The compression core 223 can determine whether data patterns (e.g., repeated sequences) are stored by the pattern circuitry 222. The compression core 223 can compress or decompress the HE data based on the data patterns.

The compression core 223 can provide the compressed data to the central controller. The central controller can cause the compressed HE data to be written back to the CXL memory device. The compressed HE data can maintain the homomorphic properties of the HE data because the HE data can be generated from the compressed HE data without loss of data and/or bits.

The command-and-control circuitry 225 can log compression results like compression ratios, latency, and/or power usage (e.g., metrics). The metrics logged by the command-and-control circuitry 225 can be used by the compression core 223. The compression core 223 can utilize the metrics to configure the models implemented by the hardware accelerators 224 to improve future compression decisions and optimize performance.

The compression system 207 can report successful compressions and/or decompressions to the host. The compression system 207 can provide resource updates to the host. The decompressed HE data can be retrieved securely. The decompressed HE data can retain encryption integrity.

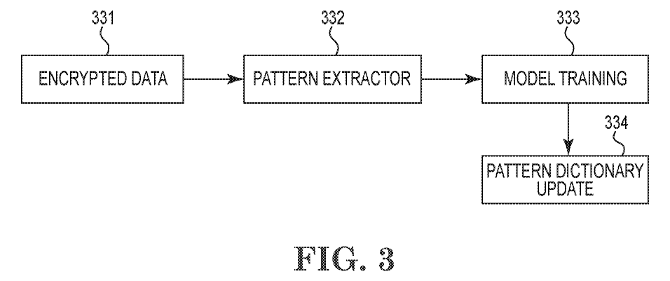

FIG. 3 is a flow diagram for model training in accordance with a number of embodiments of the present disclosure. The flow diagram can begin at 331. At 331, HE data, which can comprise training samples, can be provided to the compression system 107, 207 of FIGS. 1 and 2, respectively. At 332, data patterns can be accessed. The data patterns can be identified by a hardware accelerator or the data patterns can be provided with the training HE data.

At 333, the compression core can utilize the data patterns and the HE data to train the models of the hardware accelerator 224 of FIG. 2. In various examples, at 334, the data patterns identified by the hardware accelerator can be provided to the pattern circuitry 222 of FIG. 2. The pattern circuitry can update the data patterns by storing the data patterns. The data patterns stored can be referred to as a pattern dictionary. Training can include the updating of the machine learning models and the updating of the data patterns stored by the pattern circuitry. The machine learning model can be an ANN. The ANN can be updated by updating weights and/or biases of the ANN. The ANN can also be updated by updating activation functions, quantity of nodes, and/or layers of the ANN, among other types of training that the ANN can experience.

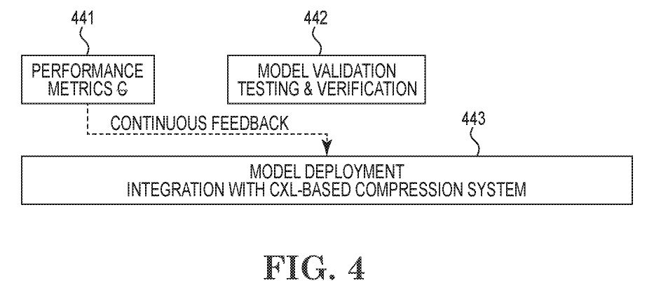

FIG. 4 is a flow diagram for model training in accordance with a number of embodiments of the present disclosure. At 441, the compression core and/or the hardware accelerator can generate performance metrics. The compression core and/or the hardware accelerator can collect the performance metrics. The performance metrics can include a time used to compress or decompress HE data, power used to compress or decompress HE data, and/or data throughput of the memory system while the HE data is compressed or decompressed, among other possible performance metrics. At 443, the compression core and/or the hardware accelerator can utilize the performance metrics to configure the hardware accelerator and/or the compression core. The configuring of the hardware accelerator and/or the compression core can be continuous. Each compression and/or decompression can be utilized to generate performance metrics. The continuous performance metrics can be utilized to continuously configure the compression core and/or the hardware accelerator. At 442, the compression core and/or the hardware accelerator can be validated to verify that the compression core and/or the hardware accelerator are functioning within an allowable tolerance of a particular metric such as power efficiency, accuracy rate, duration of time to generate compressions/decompressions, among other types or metrics.

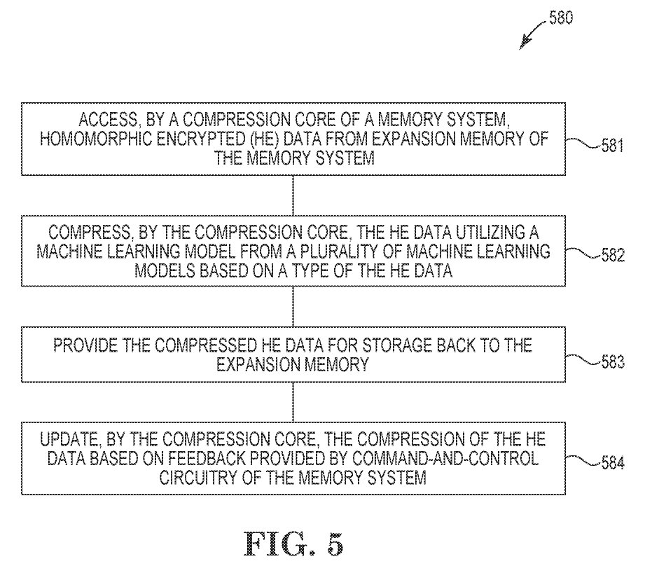

FIG. 5 is a flow diagram of a method 580 for implementing a compression system for homomorphic encrypted data in a memory system in accordance with a number of embodiments of the present disclosure. The methods described herein (e.g., with respect to FIG. 5) can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 581, a compression core of a memory system can access HE data from expansion memory of the memory system. The expansion memory can include PCIe memory, among other examples of expansion memory. The compression core can be implemented in the compression system of the memory system. The compression system can be coupled to a memory controller (e.g., central controller) of the memory system.

At 582, the compression core can compress the HE data utilizing a machine learning model from a plurality of machine learning models based on a type of the HE data. Each of the plurality of machine learning models can be customized for a different type of the HE data. The type of the HE data can be used to select a machine learning model from the plurality of machine learning models. The selected machine learning model can be used to compress the HE data. The selected machine learning model can compress the HE data more satisfactorily as compared to the other machine learning models due to being customized for the data type of the HE data. A different machine learning model can compress different HE data having a different data type more satisfactorily as compared to the selected machine learning model due due to the different machine learning model being customized for the different data type.

The type of the HE data can be a data type. The compression core can determine the data type of the HE data or can receive the data type corresponding to the HE data. The compression core can select a machine learning model from the plurality of machine learning model based on the data type of the HE data. The compression core can provide an indication of the machine learning model to the hardware accelerator. The hardware accelerator can determine the data patterns in the HE data utilizing the HE data and the machine learning model implemented by the hardware accelerator. The compression core can receive the data patterns and can obtain corresponding compression tokens. The compression core can substitute the data patterns with the compression tokens to generate the compressed HE data.

At 583, the compressed HE data can provide the compressed HE data for storage back to the expansion memory. The compression core can provide the compressed HE data to the memory controller. The memory controller can provide the compressed HE data to a corresponding memory device where the memory device is expansion memory.

At 584, the compression core can update a compression of the HE data based on feedback provided by command-and-control circuitry of the memory system. For example, the command-and-control circuitry of the memory system can gather metrics corresponding to the compression core, the pattern circuitry, and/or the hardware accelerator. The compression metrics can also be referred to as compression results. The metrics can be provided to the compression core as feedback. The compression core can make adjustment to itself, the pattern circuitry, and/or the hardware accelerator based on the feedback. Adjusting the hardware accelerator can include updating the machine learning model. Updating the machine learning model can include selecting a different machine learning model based on the data type or updating parameters of the machine learning model. For example, updating the machine learning model can include training the machine learning model. Updating parameters of the machine learning model can include updating the number of layers of the machine learning model, the bias of the machine learning model, the activation function of the machine learning model, and/or the weights of the machine learning model, among other attributes of a machine learning model that can be updated.

The machine learning models can be included in a compression model. The compression model can be refined by the compression core using a feedback loop that evaluates performance based on previous compressions of previous HE data. The command-and-control circuitry can determine and log the compression results of the compressed HE data. The compression results include a compression ratio, a compression latency, and a power usage for the compression of the HE data. Utilizing the machine learning model allows for the compression model to be refined over time (e.g., evolve over time). Utilizing a plurality of machine learning models also allows for the customization of a model to a data type. In previous approaches, a different model would have to be developed for each data type and the different models would be static.

Updating the compression of the HE data further comprises determining, by the compression core, whether the compression ratio, the compression latency, and the power usage meet a minimum level of service. Responsive to determining that the compression ratio, the compression latency, and the power usage do not meet the minimum level or service, a different machine learning model from the plurality of machine learning models can be selected based on the type of the HE data. The compression core can compress the HE data utilizing the different machine learning model.

The compression results of the compressed HE data can be determined and logged by the command-and-control circuitry. The compression of the HE data can be updated by determining, by the compression core, whether the compression ratio, the compression latency, and the power usage meet a minimum level of service. Responsive to determining that the compression ratio, the compression latency, and the power usage do not meet the minimum level or service, a different machine learning model can be selected from the plurality of machine learning models based on the type (e.g., data type) of the HE data. The HE data can be decompressed utilizing the machine learning model. Future HE data received can be compressed utilizing the machine learning model.

In a number of examples, an apparatus can be a memory system. The memory system can comprise expansion memory configured to store HE data. The memory system can also comprise a compression system. The compression system can include a compression core. The compression core can be coupled to the expansion memory. The expansion memory can include CXL memory. The compression core can be coupled to the expansion memory via a central controller and a back-end portion of the memory controller. The compression core can access the HE data from the expansion memory. The compression core can compress the HE data utilizing a machine learning model based on a type of the HE data. The machine learning model can be implemented by a hardware accelerator. The hardware accelerator can be coupled to the compression core. The compression core can provide the compressed HE data for storage back to the expansion memory. The HE data can be received from a host and stored in the expansion memory prior to being compressed by the compression core. Alternatively, the HE data can be received directly from the host and at the compression core. Receiving the data directly from the host can indicate that the data is not stored in the expansion memory prior to being provided to the compression core.

The expansion memory can include a CXL memory. The memory system can include a CXL controller coupled to the CXL memory. The CXL controller is also referred to as a memory controller 110 of FIG. 1. The CXL controller can receive the HE data and metadata corresponding to the HE data from a host via a CXL interface. The CXL controller can provide the HE data and the metadata for storage in the CXL memory. The compression core can be implemented in the CXL controller.

The memory system can also include an orchestrator unit coupled to the compression core and the CXL controller. The orchestrator unit can receive the HE data from a central controller of the CXL controller of the memory system. The orchestrator unit can determine a data type of the HE data. The compression core can comprise a plurality of a machine learning models including the machine learning model. The orchestrator unit can select the machine learning model from the plurality of machine learning models based on the data type of the HE data. The orchestrator unit can also provide an indication of the machine learning model to the compression core.

The compression core can store the compressed HE data back to the expansion memory maintaining homomorphic properties. The compressed HE data can maintain the homomorphic properties because the compressed HE data can be uncompressed to generate the original HE data without loss information and in the same format as the original HE data. The compression core can compress the HE data without performing decryption operations using the HE data to maintain the homomorphic properties of the compressed HE data. The encrypted data can be compressed instead of compressing the decrypted data and/or the encrypted data that has been further processed before compressing. The compression core can identify structural redundancies within the HE data to facilitate compression of the HE data.

In various embodiments, an apparatus can be a memory system. The memory system can include expansion memory configured to store HE data, a compression core comprising a machine learning model, and pattern circuitry. A hardware accelerator can be configured to implement a machine learning model. The pattern circuitry can store a number of repeat sequences. The number of repeat sequences can be referred to as a number of data patterns. The compression core can be coupled to the expansion memory, the pattern circuitry, and the hardware accelerator. The compression core can be coupled to the expansion memory via the memory controller.

The compression core can access the HE data from the expansion memory. The expansion memory can include UAL memory. The compression core can receive the HE data from the memory controller. The memory controller can receive the HE data from the expansion memory. The compression core can compress the HE data utilizing the machine learning model based on a type of the HE data and the number of repeated sequences stored in the pattern circuitry. The number of repeated sequences can occur in the HE data. The compression core can utilize the machine learning model to identify the number of repeated sequences. The compression core can provide the compressed HE data for storage back to the expansion memory.

The compression core can maintain entries of recurring cyphertext segments and associated compression tokens. The compression core can update the entries in response to discovery of a newly recurring cyphertext segment. The compression core can use the recurring cyphertext segments to accelerate the compression.

The compression core can replace the identified repeated sequence (e.g., recurring cyphertext segments) in the HE data with a compression token. The compression token can be small than the identified repeated sequence of bits. The pattern circuitry can provide the compression token to the compression core.

The compression core can determine that the identified repeated sequence of bits is not stored in the pattern circuitry. The pattern circuitry can store the identified repeated sequence of bits provided by the compression core responsive to the compression core determining that the identified repented sequence of bits is not stored in the pattern circuitry.

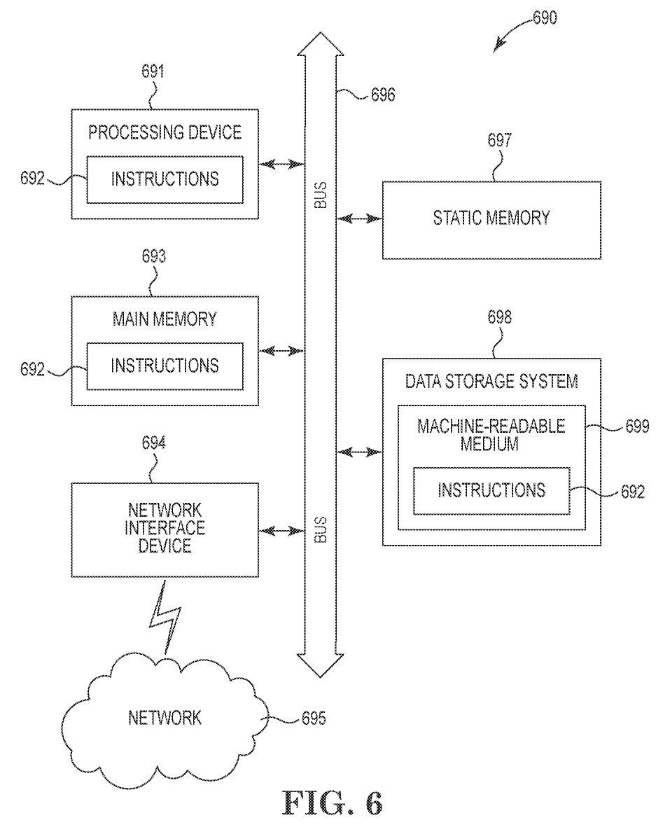

FIG. 6 illustrates an example machine of a computer system 690 within which a set of instructions, for causing the machine to perform any one or more of the methodologies discussed herein, can be executed. In some embodiments, the computer system 690 can correspond to a host system (e.g., the host 103 of FIG. 1) that includes, is coupled to, or utilizes a memory system (e.g., the memory system 112 of FIG. 1) or can be used to perform the compression system (e.g., the compression system 107 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 690 includes a processing device 691, a main memory 693 (e.g., read-only memory (ROM), flash memory, dynamic random access memory (DRAM) such as synchronous DRAM (SDRAM) or Rambus DRAM (RDRAM), etc.), a static memory 697 (e.g., flash memory, static random access memory (SRAM), etc.), and a data storage system 698, which communicate with each other via a bus 696.

Processing device 691 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 691 can also be one or more special-purpose processing devices such as an application specific integrated circuit (ASIC), a field programmable gate array (FPGA), a digital signal processor (DSP), network processor, or the like. The processing device 691 is configured to execute instructions 692 for performing the operations and steps discussed herein. The computer system 690 can further include a network interface device 694 to communicate over the network 695.

The data storage system 698 can include a machine-readable storage medium 699 (also known as a computer-readable medium) on which is stored one or more sets of instructions 692 or software embodying any one or more of the methodologies or functions described herein. The instructions 692 can also reside, completely or at least partially, within the main memory 693 and/or within the processing device 691 during execution thereof by the computer system 690, the main memory 693 and the processing device 691 also constituting machine-readable storage media.

In one embodiment, the instructions 692 include instructions to implement functionality corresponding to the compression system 107 of FIG. 1. While the machine-readable storage medium 699 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
expansion memory configured to store homomorphic encrypted (HE) data; and
a compression core comprising a machine learning model;
wherein the compression core is coupled to the expansion memory and is configured to:
access the HE data from the expansion memory;
compress the HE data utilizing the machine learning model based on a type of the HE data; and
provide the compressed HE data for storage back to the expansion memory.

2. The apparatus of claim 1, further comprising a CXL controller coupled to a CXL memory of the expansion memory and configured to:
receive the HE data and metadata corresponding to the HE data from a host via a CXL interface; and
provide the HE data and the metadata for storage in the CXL memory.

3. The apparatus of claim 2, wherein the compression core is implemented in the CXL controller.

4. The apparatus of claim 1, further comprising an orchestrator unit coupled to the compression core and a CXL controller, wherein the orchestrator unit is configured to determine a data type of the HE data.

5. The apparatus of claim 4, wherein the compression core comprises a plurality of a machine learning models including the machine learning model and wherein the orchestrator unit is further configured to:
select the machine learning model from the plurality of machine learning models based on the data type of the HE data; and
provide an indication of the machine learning model to the compression core.

6. The apparatus of claim 1, wherein the compression core is configured to compress the HE data without performing decryption operations using the HE data to maintain the homomorphic properties of the compressed HE data.

7. The apparatus of claim 1, wherein the compression core is further configured to identify structural redundancies within the HE data to facilitate compression of the HE data.

8. A method, comprising:
accessing, by a compression core of a memory system, homomorphic encrypted (HE) data from expansion memory of the memory system;
compressing, by the compression core, the HE data utilizing a machine learning model from a plurality of machine learning models based on a type of the HE data;
providing the compressed HE data for storage back to the expansion memory; and
updating, by the compression core, the compression of the HE data based on feedback provided by command-and-control circuitry of the memory system.

9. The method of claim 8, wherein the machine learning model is part of a compression model and further comprising refining, by the compression core, the compression model using a feedback loop that evaluates performance based on previous compressions of previous HE data.

10. The method of claim 8, further comprising determining and logging, by the command-and-control circuitry, compression results of the compressed HE data.

11. The method of claim 10, wherein the compression results include a compression ratio, a compression latency, and a power usage for the compression of the HE data.

12. The method of claim 11, wherein updating the compression of the HE data further comprises determining, by the compression core, whether the compression ratio, the compression latency, and the power usage meet a minimum level of service.

13. The method of claim 12, responsive to determining that the compression ratio, the compression, latency, and the power usage do not meet the minimum level or service, selecting a different machine learning model from the plurality of machine learning models based on the type of the HE data.

14. The method of claim 13, further comprising compressing, by the compression core, the HE data utilizing the different machine learning model.

15. An apparatus, comprising:
expansion memory configured to store homomorphic encrypted (HE) data;
a compression core comprising a machine learning model;
pattern circuitry;
wherein the compression core is coupled to the expansion memory and the pattern circuitry and is configured to:
access the HE data from the expansion memory;
compress the HE data utilizing the machine learning model based on a type of the HE data and a number of repeated sequences stored in the pattern circuitry; and
provide the compressed HE data for storage back to the expansion memory.

16. The apparatus of claim 15, wherein the compression core is configured to:
maintain entries of recurring cyphertext segments and associated compression tokens;
update the entries in response to discovery of a newly recurring cyphertext segment; and
use the recurring cyphertext segments to accelerate the compression.

17. The apparatus of claim 15, wherein the compression core is further configured to identify a repeated sequence of bits in the HE data.

18. The apparatus of claim 17, wherein the compression core is further configured to replace the identified repeated sequence in the HE data with a compression token wherein the identified repeated sequence of bits is smaller than the compression token and wherein the pattern circuitry is configured to provide the compression token to the compression core.

19. The apparatus of claim 17, wherein the compression core is further configured to determine that the identified repeated sequence of bits is not stored in the pattern circuitry.

20. The apparatus of claim 19, wherein the pattern circuitry is further configured to store the identified repeated sequence of bits provided by the compression core responsive to the compression core determining that the identified repented sequence of bits is not stored in the pattern circuitry.
